(19) United States
(12) Patent Application Publication
(10) Pub. No.: US 2015/0031408 A1
(43) Pub. Date: Jan. 29, 2015

(54) System and Methods for Controlling Transmit Power on Multi-SIM Devices in Compliance with Specific Absorption Rate Limits

(71) Applicant: QUALCOMM Incorporated, San Diego, CA (US)

(72) Inventors: Naveen KALLA, San Diego, CA (US); Francis M. Ngai, Louisville, CO (US); Niranjan Pendharkar, San Diego, CA (US); Hemanth Kosaraju, San Diego, CA (US)

(73) Assignee: QUALCOMM Incorporated, San Diego, CA (US)

(21) Appl. No.: 13/950,449

(22) Filed: Jul. 25, 2013

(51) Int. Cl. H04W 52/38; H04W 88/06

(52) U.S. Cl. CPC H04W 52/38; H04W 88/06
USPC 455/522

(57) ABSTRACT

Methods and devices are disclosed for control total transmit power within specific absorption rate (SAR) limits when a multi-SIM wireless device, such as a dual-SIM dual active (DSDA) device, has two active data communications. Embodiment methods include determining a priority of at least one of two active data communications based upon a measured condition of the wireless device, and reducing transmit power on one of the two RF resources supporting one of the two active data communications with lower priority. To identify a higher or lower priority active data communication, characteristics of the communications or data may be used.

### FIELD

The present invention relates generally to multi-SIM wireless communication devices, and more particularly to methods of preventing the power level of wireless signals from exceeding a prescribed level during simultaneous data communications in a multi-radio dual-SIM dual active (DSDA) wireless communication device.

### BACKGROUND

In order to operate on a cellular network, the transmit/receive chain (e.g., transceiver) in a wireless device uses radio frequency (RF) energy. Various regulatory authorities require transmit components in wireless devices to comply with safety standards relating to RF radiation. For example, when a wireless device is held next to a user's ear or worn at hip level, the amount of RF energy absorbed by the user must not exceed a specified limit known as the specific absorption ratio (SAR) limit. While previous multi-SIM devices in which SIMs shared radio resources are not affected by such limits, DSDA devices could exceed SAR limits when two radios are simultaneously transmitting signals for both SIMs.

Dual-SIM mobile devices have become increasing popular because of their flexibility in service options and other features. One type of dual-SIM mobile device, a dual-SIM dual active (DSDA) device, allows simultaneous active connections with the networks corresponding to both SIMs. DSDA devices typically have separate transmit/receive chains associated with each SIM. In this manner, a DSDA wireless device enables the active communications on each SIM to connect simultaneously without competing for resources.

When transmitting data, it is desirable to utilize a maximum transmit power to send data at a high rate. However, the use of maximum transmit power for more than one active communication may exceed the SAR limit when more than one radio resource is used, such as in DSDA mobile devices.

### SUMMARY

Systems, methods, and devices of the various embodiments enable a multi-radio device to perform actions to limit total power transmissions of a multi-SIM wireless device participating in two or more active data communications, supported by two or more RF resources, by determining a priority of the two or more active data communications based upon a measured condition of the wireless device and attributes of the active data communications. The determined priority may then be used to limit total power of transmissions by reducing transmit power on at least one of the two or more radio frequency (RF) resources supporting at least one of the two or more active data communications with lower priority.

In an embodiment, limiting total power transmissions of a multi-SIM wireless device participating in two or more active data communications that are supported by two or more RF resources may include identifying a foreground application running on the wireless device, identifying one of the active data communications as being associated with the foreground application, and assigning higher priority to the active data communication associated with the foreground application. In another embodiment, limiting total power transmissions of a multi-SIM wireless device participating in two or more active data communications that are supported by two or more RF resources may include measuring transmit power on each of the two or more RF resources, and calculating a sum of transmit powers on all of the two or more RF resources. In this embodiment, determining a priority may include determining a data transmission requirement on each of other RF resources, and assigning higher priority to the RF resource associated with the greatest data transmission requirement. Data transmission requirements may be determined based on a number of pending data packets in a data queue associated with a particular protocol layer implemented by the RF resource to transmit data. Data transmission requirements may also be determined based on the amount of data sent over each network interface supporting at least one of the two or more active data communications during a past sampling period.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a communication system block diagram of a network suitable for use with the various embodiments.

FIG. 2 is a block diagram illustrating a dual-SIM dual active device according to an embodiment.

FIG. 3 is a block diagram illustrating simultaneous transmissions in a dual-SIM dual active device according to an embodiment.

FIG. 4 is a process flow diagram illustrating an embodiment method for reducing total SAR in a dual-SIM dual active device.

FIG. 5 is a block diagram illustrating a software protocol stack architecture in a dual-SIM dual active device according to the various embodiments.

FIG. 6 is a process flow diagram illustrating an embodiment method for reducing total SAR in a multi-SIM wireless device.

FIG. 7 is a process flow diagram illustrating an embodiment method for reducing total SAR in a multi-SIM wireless device.

FIG. 8 is a process flow diagram illustrating an embodiment method for reducing total SAR in a multi-SIM wireless device.

FIG. 9 is a component diagram of an example mobile device suitable for use with the various embodiments.

FIG. 10 is a component diagram of another example mobile device suitable for use with the various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

The terms “wireless device,” “wireless communications device,” and “mobile device” are used interchangeably herein to refer to any one or all of cellular telephones, smart phones, personal or mobile multi-media players, personal data assistants (PDAs), laptop computers, tablet computers, smart books, palm-top computers, wireless electronic mail receivers, multimedia Internet enabled cellular telephones, wireless gaming controllers, and similar personal electronic devices that include a programmable processor and memory and circuitry for establishing wireless communication pathways and transmitting/receiving data via wireless communication pathways.

As used herein, the terms “SIM”, “SIM” and “subscriber identification module” are used interchangeably to mean an integrated circuit, which may be embedded into a removable card or integral to the wireless device, that stores an International Mobile Subscriber Identity (IMSI), related key, and/or other information used to identify and/or authenticate a wireless device on a network. The term “SIM” may also be used as a shorthand reference to a communication network associated with a particular SIM, since the information stored in a SIM enables the wireless device to establish a communication link with a particular network, thus the SIM and the communication network correlate to one another. The term “SIM” may also be used to relate to a particular radio circuit used to communicate with the communication network associated with a particular SIM.

As used herein, the terms “multi-SIM device,” “multi-SIM wireless device” “dual-SIM device” “dual-SIM dual active device” and “DSDA device” are used interchangeably to describe a wireless device that is configured with more than one SIM that is capable of independently handling communications with networks of two subscriptions.

As used herein the terms “Specific Absorption Rate” and “SAR” are used interchangeably to refer to regulatory limitations on the rate at which radio frequency (RF) electromagnetic energy may be absorbed by the human body imposed on wireless devices.

Increasingly, wireless communication devices have capabilities for simultaneously handling multiple subscriber identification models (SIMs). For example, dual-SIM dual active (DSDA) wireless devices allow active communications on each subscription at the same time. These SIMs may be associated with different access networks and/or be configured to handle different types of communication. In a DSDA device, each SIM may be associated with its own baseband processor and transmit/receive chain. In this manner, a DSDA wireless device enables the active communications on each SIM to connect simultaneously without competing for resources.

In order to operate on a cellular network, the transmit/receive chain (e.g., transceiver) in a wireless device emits radio frequency (RF) energy. Various regulatory authorities require transmit components in wireless devices to comply with safety standards relating to RF radiation exposure. For example, when a wireless device is held next to a user's ear or worn at hip level, the amount of RF energy absorbed by the user must not exceed a specified limit known as the specific absorption ratio (SAR) limit. The SAR limit set for the United States and Canada by the Federal Communications Commission (FCC) and Industry Canada of the Canadian Government, respectively, is 1.6 W/kg averaged over 1 gram of actual tissue. The SAR limit recommend by the Council of the European Union is 2.0 W/kg averaged over 10 g of actual tissue. The SAR limit in the various embodiments may be a maximum absorption rate stated in regulations of a government agency or may be a SAR value that has been selected for use according to some other method.

While multiple simultaneous communications may be desirable in wireless devices, the cumulative RF energy emitted from the multiple transmit components at full power could exceed the specified SAR limit. As a result, it may be necessary to decrease transmit power on one of the communications. Mechanisms for determining priority between multiple voice communications, or one voice and one data communication, may be based on inherently differences in the technologies, a user location or preference, etc. However such mechanisms may not be applicable when the active communications are both data communications.

The various embodiments provide systems and methods for decreasing the total RF energy emitted by a wireless device to below the maximum SAR limit when multiple data transmissions are active. In the various embodiments, a priority may be determined between multiple data active data communications on a wireless device based upon a measured condition of the wireless device, and the transmit power on RF resource supporting the active data communication with the lowest priority transmissions may be decreased. The various embodiments provide a variety of methods for determining the relative priority of the two data communications in order to ensure the higher priority communication link can transmit at sufficient power to accomplish reliable communications. In particular, the priority determination may be based on whether applications are running in the foreground versus the background, or based on the amount of data to be sent or recently in each data communication link. By evaluating characteristics that are indicative of the respective data traffic for each of the active data communication links, a lower priority communication can be identified so that its transmit power may be reduced.

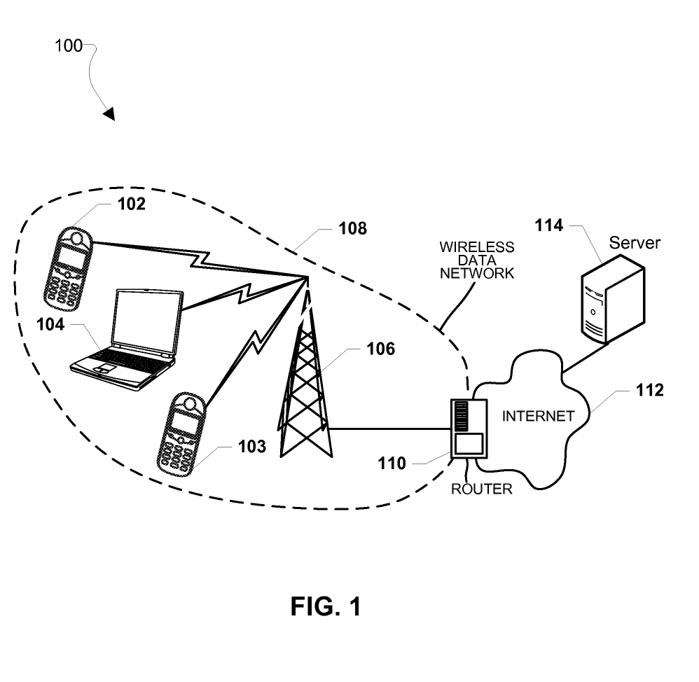

FIG. 1 illustrates a wireless network system 100 suitable for use with the various embodiments. Wireless communications devices 102, 103, and 104 and a wireless cell tower or base station 106 together make up a wireless data network 108. Using the wireless data network 108, data may be transmitted wirelessly between the wireless devices 102, 103, and 104 and the wireless cell tower or base station 106. The transmissions between the wireless devices 102, 103, and 104 and the wireless cell tower or base station 106 may be by any cellular networks, including Wi-Fi, CDMA, TDMA, GSM, PCS, G-3, G-4, LTE, or any other type connection. The wireless data network 108 may be in communication with a router 110 which connects to the Internet 112. In this manner data may be transmitted from/to the wireless devices 102, 103, and 104 via the wireless network 108, and router 110 over the Internet 112 to/from a server 114 by methods well known in the art.

Some or all of the wireless devices 102 may be configured with multi-mode capabilities and may include multiple transceivers for communicating with different wireless networks over different wireless links/radio access technologies (RATs). For example, a wireless device 102 may be configured to communicate over multiple wireless data networks on different subscriptions, such as in a dual-SIM wireless device. In particular, a wireless device 102 may be configured with dual-SIM dual active (DSDA) capability, which enables a dual-SIM device to simultaneously participate in two independent communications sessions, generally though independent transmit/receive chains.

While the techniques and embodiments described herein relate to a wireless device configured with multiple GSM subscriptions, they may be extended to subscriptions on other radio access networks (e.g., UMTS, WCDMA, LTE, etc.).

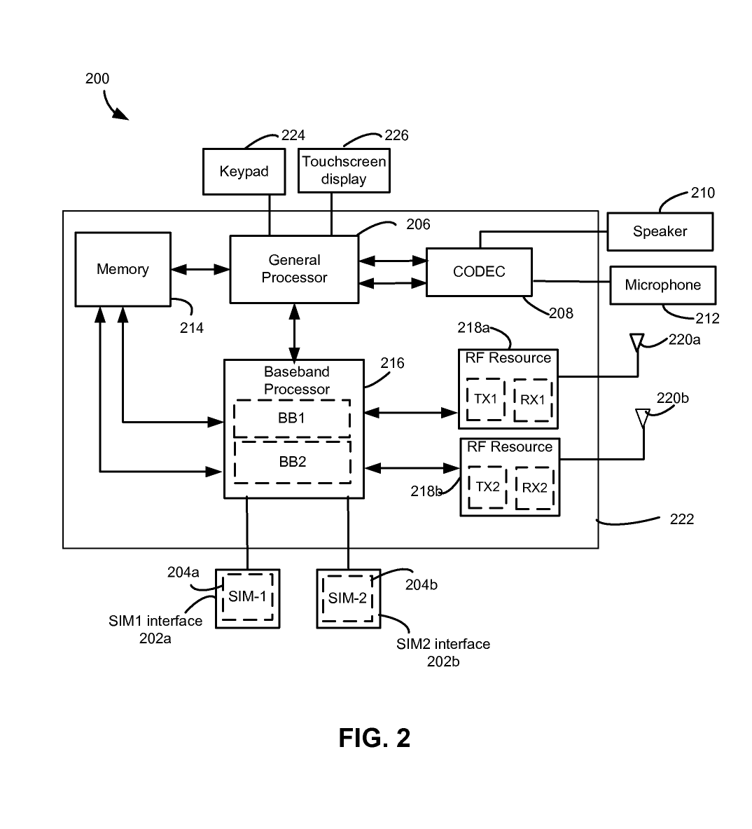

FIG. 2 is a functional block diagram of a multi-SIM wireless device 200 that is suitable for implementing the various embodiments. Wireless device 200 may include a first SIM interface 204a, which may receive a first identity module SIM-1 202a that is associated with the first subscription. The wireless device 200 may also include a second SIM interface 204b, which may receive a second identity module SIM-2 202b that is associated with the second subscription.

A SIM in the various embodiments may be a Universal Integrated Circuit Card (UICC) that is configured with SIM and/or USIM applications, enabling access to GSM and/or UMTS networks. The UICC may also provide storage for a phone book and other applications. Alternatively, in a CDMA network, a SIM may be a UICC removable user identity module (R-UIM) or a CDMA subscriber identity module (CSIM) on a card.

Each SIM may have a CPU, ROM, RAM, EEPROM and I/O circuits. A SIM used in the various embodiments may contain user account information, an international mobile subscriber identity (IMSI), a set of SIM application toolkit (SAT) commands and storage space for phone book contacts. A SIM may further store a Home Public-Land-Mobile-Network (HPLMN) code to indicate the SIM network operator provider. An Integrated Circuit Card Identity (ICCID) SIM serial number is printed on the SIM for identification.

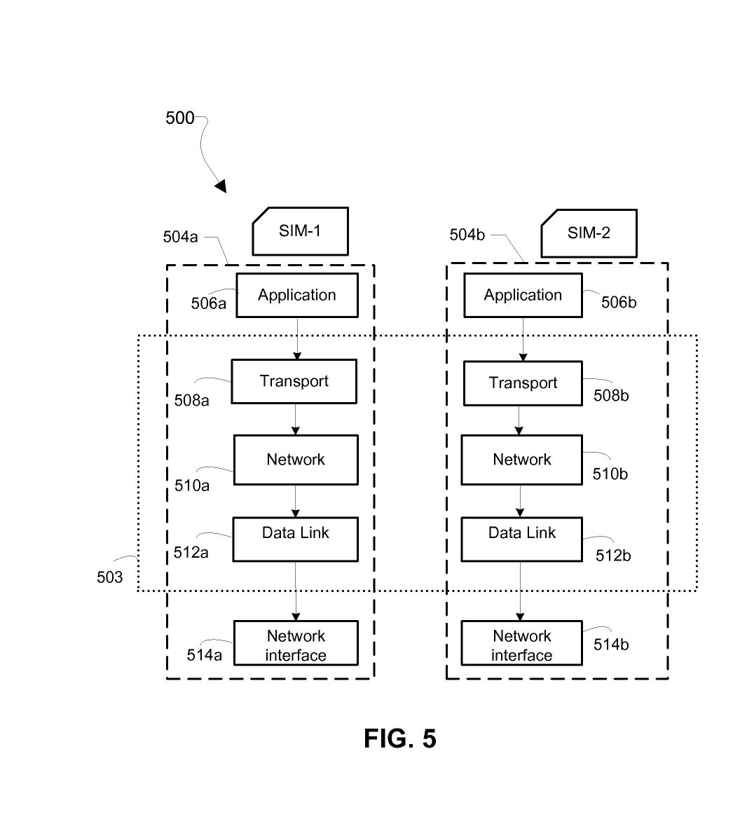

Wireless device 200 may include at least one controller, such as a general processor 206, which may be coupled to a coder/decoder (CODEC) 208. The CODEC 208 may in turn be coupled to a speaker 210 and a microphone 212. The general processor 206 may also be coupled to at least one memory 214. Memory 214 may be a non-transitory tangible computer readable storage medium that stores processor-executable instructions. For example, the instructions may include routing communication data relating to the first or second subscription though a corresponding baseband-RF resource chain. The memory 214 may store operating system (OS), as well as user application software and executable instructions. The memory 214 may also store data queues in pending data communications, such as those described in further detail below with respect to FIG. 5.

The general processor 206 and memory 214 may each be coupled to at least one baseband modem processor 216. Each SIM in the wireless device 200 (e.g., SIM-1 202a and SIM-2 202b) may be associated with a baseband-RF resource chain. Each baseband-RF resource chain may include baseband modem processor 216 to perform baseband/modem functions for communications on a SIM, and one or more amplifiers and radios, referred to generally herein as RF resources 218. In one embodiment, each baseband-RF resource chain may include physically or logically separate baseband processors (e.g., BB1, BB2). Alternatively, baseband-RF resource chains may share a common baseband modem processor (i.e., a single device that performs baseband/modem functions for all SIMs on the wireless device).

RF resources 218a, 218b may each be transceivers that transmit and receive RF signals and perform the signal encoding/decoding functions on such signals for the associated SIM of the wireless device. RF resources 218a, 218b may include separate transmit and receive circuitry, or may include a transceiver that combines transmitter and receiver functions. The RF resources 218a, 218b may be coupled to a wireless antenna (e.g., a first wireless antenna 220a and a second wireless antenna 220b). The at least one memory 214 of the wireless device 200 may store an operating system (OS) and user application software. In the various embodiments, data communications may be performed on RF resources 218a, 218b by implementing respective protocol stacks to send and receive data via separate network interfaces associated with RF resources 218a, 218b.

In a particular embodiment, the general processor 206, memory 214, baseband processor(s) 216, and RF resources 218a, 218b may be included in a system-on-chip device 222. The first and second SIMs 202a, 202b and their corresponding interfaces 204a, 204b may be external to the system-on-chip device 222. Further, various input and output devices may be coupled to components of the system-on-chip device 216, such as interfaces or controllers. Example user input components suitable for use in the wireless device 200 may include, but are not limited to, a keypad 224 and a touchscreen display 226.

In an embodiment, the keypad 224, touchscreen display 226, microphone 212, or a combination thereof, may perform the function of receiving the request to initiate an outgoing call. For example, the touchscreen display 226 may receive a selection of a contact from a contact list or receive a telephone number. In another example, either or both of the touchscreen display 226 and microphone 212 may perform the function of receiving a request to initiate an outgoing call. For example, the touchscreen display 226 may receive selection of a contact from a contact list or to receive a telephone number. As another example, the request to initiate the outgoing call may be in the form of a voice command received via the microphone 212. Interfaces may be provided between the various software modules and functions in wireless device 200 to enable communication between them, as is known in the art.

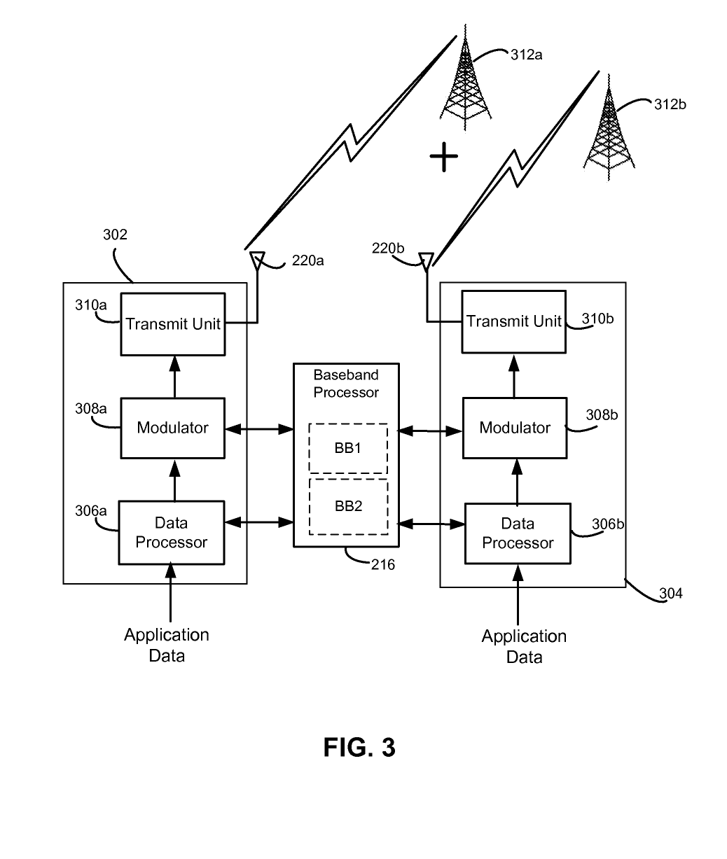

FIG. 3 is a block diagram of transmit components in separate RF resources, the output power of which may be combined during simultaneous transmissions. For example, a transmitter 302 may be part of one RF resource 218a, and a transmitter 304 may be part of another RF resource 218b, as described above with reference to FIG. 2. In a particular embodiment, the transmitters 302, 304 may include data processors 306a, 306b to format, encode, and interleave data to be transmitted. The transmitters 302, 304 may include modulators 308a, 308b that modulates carrier signals with encoded data, for example, by performing Gaussian minimum shift keying (GMSK). One or more transmit circuits 310a, 310b may condition modulated signals (e.g., by filtering, amplifying, and upconverting) to generate RF modulated signals for transmission. The RF modulated signals may be transmitted, for example, to base stations 312a, 312b via antennas, such as antennas 220a, 220b as shown in FIG. 2. In an alternative embodiment, both SIMs may be configured to connect to the same access network, and therefore base stations 312a, 312b may be a single base station. In an embodiment, during simultaneous data communications the total transmit power on a device with RF resources 218a, 218b may be a sum of the transmit power of the RF modulated signals from antennas 220a, 220b.

Operations of the transmitters may be controlled by a processor, such as a baseband processor(s) 206 as illustrated in FIG. 2. In the various embodiments, each of the transmitter 302, 304 and may be implemented as circuitry that is separated from their corresponding receive circuitries (not shown). Alternatively, the transmitters 302, 304 may be respectively combined with corresponding receive circuitry (i.e., as transceivers associated with SIM-1 and SIM-2).

As discussed above, the embodiment methods may control transmit power on a multi-SIM wireless device so that the total transmission power on the device does not exceed a specific absorption rate limit, thereby limiting the user's exposure to RF energy. While example embodiments are discussed in terms of reducing total transmit power for two active data communications associated with two SIMs, additional SIMs and network connections may be enabled in a multi-SIM wireless device.

In the various embodiments, upon establishing active data communications on the RF resources associated with both SIMs, the wireless device may implement an algorithm in order to select an RF resource on which to reduce transmit power.

In one embodiment, the wireless device may determine that the total transmit power exceeds the applicable SAR limit through actual direct or indirect measurement of output power on the RF resource associated with each SIM. These measurements may be performed using techniques and equipment that are known to those of ordinary skill in the art. Optionally, the resulting measurements may be normalized or weighted to account for differences between units across different radio access network standards. The output power measurements, or normalized/weighted measurements, may be added together, and the total may be compared to the SAR limit.

In an alternative embodiment, the wireless device may assume that combined transmit power will exceed the SAR limit if a power reduction is not performed on one transmitter simply upon establishing more than one active data communication. The device may be configured to automatically employ the SAR-compliance mitigation algorithm without requiring any further measurement or determination operation, thereby increasing expediency of the system, but potentially leading to reduced transmit power even when the total power would be below the SAR limit without mitigation. In another alternative embodiment, the operation of detecting whether the total transmit power exceeds the applicable SAR limit may performed by detecting more than one active data transmission and determining whether both active data transmission are operating at their respective maximum signal transmit power.

Upon determining that the total transmit power exceeds the SAR limit, the wireless device may employ a mitigation algorithm to reduce transmit power on the RF resource associated with a lower relative priority transmission. The embodiment algorithms use various characteristics associated with the RF resources and/or their active data communications as indicators of the respective data transmission needs in that active data communication. In one embodiment, transmission priority may be allocated based on a foreground application linked to one communication link or the other. In another embodiment, transmission priority may be allocated based on the relative amounts of data involved in each transmission (e.g., data awaiting transmission or data recently transmitted). Transmit power reductions as a result of the algorithm may involve, for example, reducing transmit power by a predetermined amount and/or temporarily shutting off an RF resource for a predetermined period of time, after which the RF resource may be powered back on.

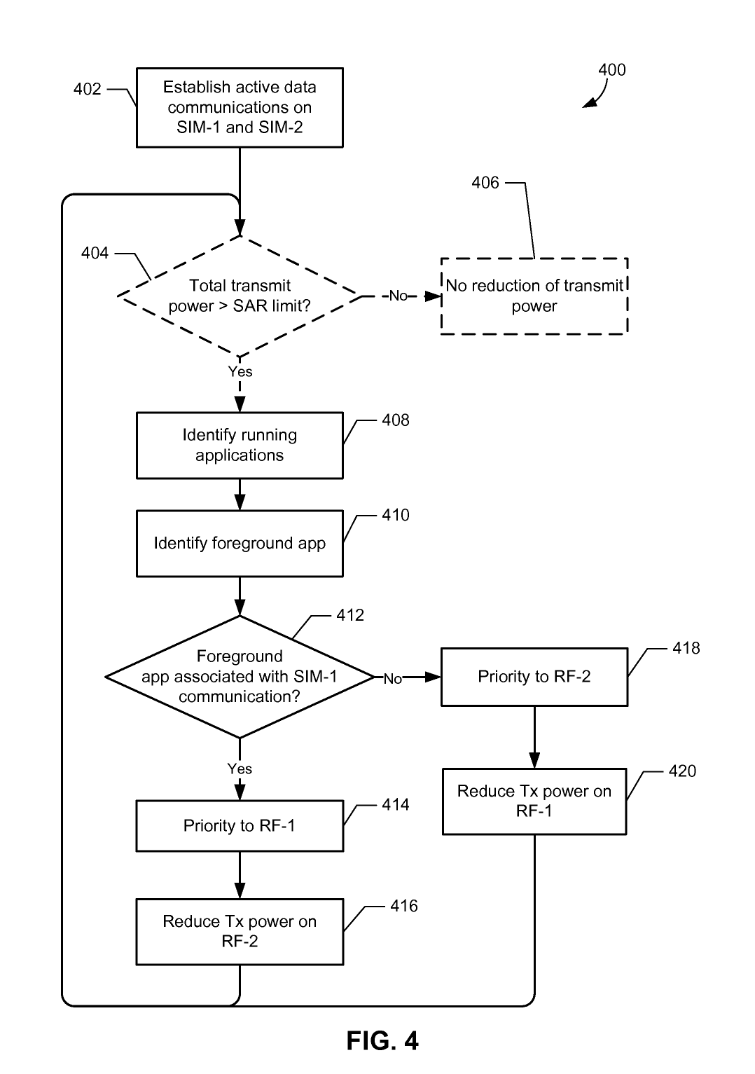

FIG. 4 illustrates an embodiment method 400 for reducing total transmit power on a multi-SIM device that has two active data communications that operates on the assumption that an application running in the foreground indicates a higher relative data transmission requirement and assigns priority accordingly. The operations of method 400 may be implemented by one or more processors of the wireless device, such as the general processor 206 shown in FIG. 2, or a separate controller (not shown) that may be coupled to memory and to the baseband modem processor(s) 216.

In block 402 of method 400, a processor of the multi-SIM wireless device may establish or detect the existence of simultaneous active data communications on two different SIMs (i.e., SIM-1 and SIM-2), associated with respective RF resources (i.e., RF-1 and RF-2). In optional determination block 404, the wireless device processor may also determine whether the total transmit power on RF-1 and RF-2 is greater than a SAR limit using various known methods as discussed above. As mentioned above, this determination is optional because an embodiment may presume the need to reduce power in one transmitter based solely on the existence of two simultaneous active data communications. If the processor determines that the total transmit power is not greater than the SAR limit (i.e., optional determination block 404=“No”), the wireless device processor may take no action to reduce the transmit power on RF-1 or RF-2 in optional block 406. This process may be repeated continuously by returning to optional determination block 404 periodically to determine whether total transmit power is exceeding the SAR limit.

If the processor determines that the total transmit power is greater than the SAR limit (i.e., optional determination block 404=“Yes”), or if it is presumed that the SAR limit is being exceeded by two simultaneous connections, the wireless device processor may identify the applications that are currently running on the device associated with the two simultaneous connections in block 408. In block 410, the wireless device may identify the foreground application among the applications that are running on the device. Such identification may be based, for example, on triggers, API calls or data flows from the applications that are indicative of foreground activity (e.g., handling an Activated event caused by user input that switches focus). In determination block 412, the wireless device processor may determine whether the foreground application is associated with the active data communication on SIM-1 (or SIM-2). If the foreground application is associated with the active data communication on SIM-1 (i.e., determination block 412=“Yes”), the wireless device processor may give higher relative priority to RF-1 in block 414, and the transmit power on RF-2 (i.e., lower relative priority) may be reduced in block 416. This process may be repeated continuously by returning to optional determination block 404 periodically to determine whether total transmit power is exceeding the SAR limit. Repeating the process also enables the priority to be switched if the foreground application changes to be associated with SIM-2 (or vice versa).

If the foreground application is not associated with the active data communication on SIM-1 (i.e., determination block 412=“No”), the wireless device processor may give higher relative priority to RF-2 in block 418, and the transmit power on RF-1 (i.e., lower relative priority) may be reduced in block 420. Again, the process may be repeated continuously by returning to optional determination block 404 periodically to determine whether total transmit power is exceeding the SAR limit and reassessing the foreground application to accommodate any changes.

In other embodiment methods for reducing total transmit power on a multi-SIM device, measures of pending data traffic for each active communication may be used to determine current data transmission requirements. As discussed above with reference to FIG. 2, data communications may be performed on RF-1 and RF-2 by implementing respective protocol stacks to send and receive data via separate network interfaces. Each SIM of the multi-SIM device may be associated with a corresponding baseband-RF resource chain. The baseband-RF resources chain associated with each SIM may implement its own protocol stack in the operating system (OS) kernel. In this manner, both SIMs may simultaneously engage in active data communication via separate network interfaces that support the physical and logical requirements of the network protocol.

FIG. 5 illustrates an example block diagram of software architecture with layered protocol stacks that may be used in data communications on a DSDA wireless device. Layers of each protocol stack may be implemented in hardware, in software, or in a combination of hardware and software. In an embodiment, each layer of the protocol stacks may be implemented as a module, with the layers modeled in a stack arrangement because each layer may communicate with two “adjacent” other layers.

A DSDA wireless device (e.g., wireless device 200 in FIG. 2) may have a software architecture 500 with multiple protocol stacks, each of which may be associated with a different SIM. For example, wireless device 200 may be configured with protocol stacks 504a, 504b associated with SIMs 208a, 208b in FIG. 2. Protocol stacks 504a, 504b may support any of variety of standards and protocols for wireless communications. In an embodiment protocol stacks 504a, 504b may each have an application layer, transport layer, network layer, data link layer, and network interface. In an embodiment, some of the layers of protocol stacks 504a, 504b (e.g., transport, network, and data link layers) may be implemented in an OS kernel 503 of the wireless device.

Application layers 506a, 506b may form the top layers of the protocol stacks 504a, 504b. Application layers 506a, 506b may provide software services that allow user applications to interact with the network. Example application layer protocols may include, but are not limited to, FTP, SMTP, HTTP, etc. In an embodiment, the software architecture 500 may further include at least one host layer that provides application-specific functions to both SIMs by providing an interface between protocol stacks 504a, 504b and a general processor (e.g., the general processor 206 shown in FIG. 2).

Transport layers 508a, 508b may provide datagram services to respective application layers 506a, 506b. Specifically, transport layers 508a, 508b may allow exchange of messages between the host wireless device and a destination device. Further services that may be handled by transport layers 508a, 508b include error control, congestion control, and flow control. Example transport layer protocols may include, but are not limited to, Transmission Control Protocol (TCP) and User Datagram Protocol (UDP).

Network layers 510a, 510b may provide services to the respective transport layers 508a, 508b, such as routing data packets on the network to the destination device. The network layers 510a, 510b may create datagrams by adding source and destination logical address information to data from respective transport layers 508a, 508b. Example network layer protocols may include, but are not limited to, Internet Protocol (IP) and (Internet Control Message Protocol (ICMP). In an embodiment, each network layer 510a, 510b may also be partitioned into one or more sub-layers (not shown).

Data link layers 512a, 512b may provide services to respective network layers 510a, 510b. Specifically, data link layers 512a, 512b may establish connections over air interfaces, handle output data for transmission, and manage network resources for the wireless device 300. Data link layers 512a, 512b may also add local address information to the output data received from the network layers 510a, 510b respectively to create frames. In an embodiment, each data link layer 512a, 512b may contain various sub-layers (e.g., media access control (MAC) and logical link control (LLC) layers).

In an embodiment, the OS kernel 503 may implement the functions in the transport layers 508a, 508b, network layers 510a, 510b, and data link layers 512a, 512b. Network interfaces 514a, 514b may reside between the kernel layers and communication hardware (e.g., one or more RF resources). In an embodiment, network interfaces 514a, 514b may implement the circuitry required for the operating system to send data on the network over a transmission medium. In particular, network interfaces 514a, 514b may interface with radio components that transmit a signal, and may pass the data to be transmitted from the kernel 503. In alternative embodiments, some or all of the network interface functions may be performed by layers within the kernel 503, such as the data link layers 512a, 512b.

Using any of a variety of communication links (as LTE, 4G, 3G, CDMA, TDMA, and other cellular telephone communication technologies), applications for each SIM may communicate wirelessly over an air interface with a base station of a wireless network. In some embodiments, the base station of the wireless network may be coupled upstream to a gateway that links to a packet-based network (e.g., the Internet). In the various embodiments, the baseband-RF resource chain may include one or more additional protocol layers that are specific to a cellular network standard (e.g., GSM/GAP protocols).

In sending data from the wireless device 200 (i.e., a host device) to the respective destination devices (not shown), data may pass through multiple buffers and data queues associated with the modules that implement various layers in protocol stacks 504a, 504b. For example, when an application creates a message for transmission, data in the user area may be copied to kernel memory and added to a send socket buffer. The send socket buffer may be used to address and manage the data packet throughout processing in the kernel.

Data that is being processed for transmission may traverse the protocol layers in the kernel, passing vertically between adjacent protocol layers. Each protocol layer may handle the data and control information (i.e., protocol data unit (PDU)) passed down from the previous layer, and may add further control information to create a new layer-specific PDU. To facilitate this process, stack management methods may use buffers in kernel memory to contain all or part of each PDU at each layer. In this manner, data may be copied from one buffer to another as it moves down a protocol stack. For example, a stack management method in an embodiment may be based on a buffer that uses a first-in first-out data queue. Additionally, data queues that provide flow control and/or congestion control may be implemented in the transport, network and data link layers of protocol stacks 504a, 504b.

From the OS kernel, data may be passed through a transmit queue to a network interface driver. The transmit queue may be stored in host memory in a series of buffers. Therefore, at each layer of the protocol stacks 504a, 504b the data that has been passed down from the layer above but has not yet been sent to the layer below may be found in a data queue or buffer. In an embodiment, the size of one or more of the data queues in or between layers may be utilized to determine or estimate the number of pending data packets to be sent over the respective network interfaces. Information regarding the amount of data pending for transmission in a particular protocol stack layer (i.e., the size of a data queue) is referred to herein as a “watermark” of the state or activity within the protocol stack. Watermarks for protocol stacks 504a, 504b may be exposed to the system by modifying the drivers of respective network interfaces 514a, 514b. In an embodiment, the wireless device may compare these watermarks to identify the communication link that has more data pending in the data queue for transmission (or for decoding in the case of a watermark related to the receive process). Thus, the watermarks provide an easy reference for identifying the busier communication link. In an embodiment, data link layers 512a, 512b may implement the network interface drivers corresponding to network interfaces 514a, 514b.

While the techniques and embodiments described herein relate to layers of a TCP/IP type protocol stack model, they may be extended to other protocol stack models (e.g., OSI model) or architectures. Further, the divisions between the various layers are provided merely as examples, since the protocol stack arrangement herein is only one of many hierarchical arrangements of the same or other abstraction layers.

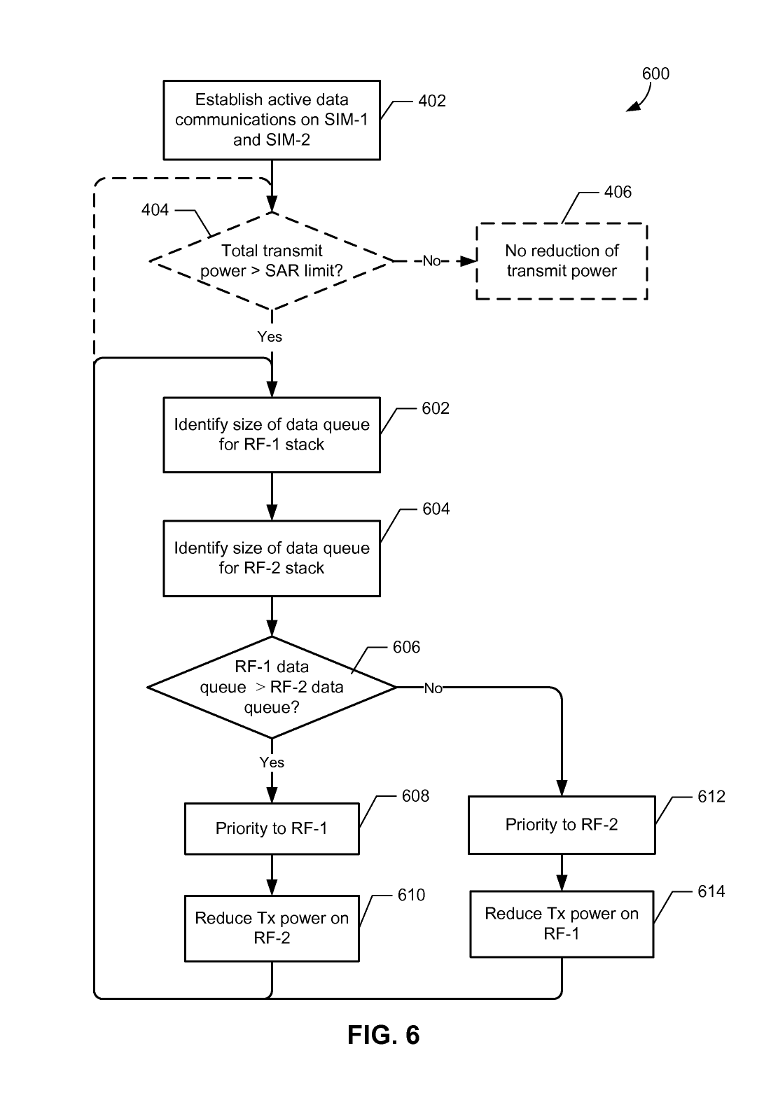

FIG. 6 illustrates an embodiment method 600 for reducing total transmit power based on the amount of pending data. Specifically, method 600 utilizes the size of a data queue in the protocol stack of the active communication links to determine current data transmission/reception demands in each link. Method 600 may begin with the operations in blocks 402-406 described above with reference to FIG. 4.

In block 602, the wireless device processor may determine the amount of pending data at a layer of the protocol stack for RF-1, and in block 604 the wireless device processor may determine the amount of pending data at a layer of the protocol stack for RF-2. The amount of pending data may be determined, for example, by identifying the size of a send queue for a particular layer in the associated protocol stack as discussed above.

In determination block 606, the wireless device processor may determine whether the data queue associated with RF-1 is larger than the data queue associated with RF-2 (or vice versa). If the data queue associated with RF-1 is greater than the data queue associated with RF-2 (i.e., determination block 606=“Yes”), the wireless device processor may give higher relative priority to RF-1 in block 608, and the transmit power on RF-2 (i.e., lower relative priority) may be reduced in block 610. If the data queue associated with RF-1 is not greater than the data queue associated with RF-2 (i.e., determination block 606=“No”), the wireless device processor may give higher relative priority to RF-2 in block 612, and the transmit power on RF-1 (i.e., lower relative priority) may be reduced in block 614. The operations in blocks 602-614 may be repeated periodically to dynamically account for changes in the relative amounts of pending data for each RF resource. For example, an RF-resource initially assigned the lower priority and allocated lower power, and thus operating with a lower data transmission rate, may result in that communication link building up a backlog of data in its transmission queue, while the RF-resource initially assigned higher priority and higher power may quickly clear its transmission queue. Consequently, repeating the operations in blocks 602-614 may result in switching the priority RF resources. As a result method 600 may enable both communication links to achieve their required data transmission rates when averaged over a longer period of time without exceeding the SAR limit at any given instant. Optionally, the processor may also periodically determine whether the total transmit power would exceed the SAR limit without a power reduction in optional determination block 404. In this manner, the processor may stop reducing the power level of one of the RF resources when such mitigation actions are not required, thereby enabling both communication links to operate at power levels set by their respective networks.

In another embodiment, the transmission needs for each data communication may be characterized by the amount of data that was transmitted during a previous time interval (i.e., a sampling period), which provides another measure for how busy each communication link is. In an embodiment, this recent data traffic measure may be determined using information provided in the /proc filesystem, which provides a direct reflection of the system kept in memory. For example, a pseudo-file in the /proc file system may identify the packets sent on each network interface, as well as the time at which they were sent. Using this information, the number of packets that were sent during a sampling period (for example, the previous 1 ms) may be determined.

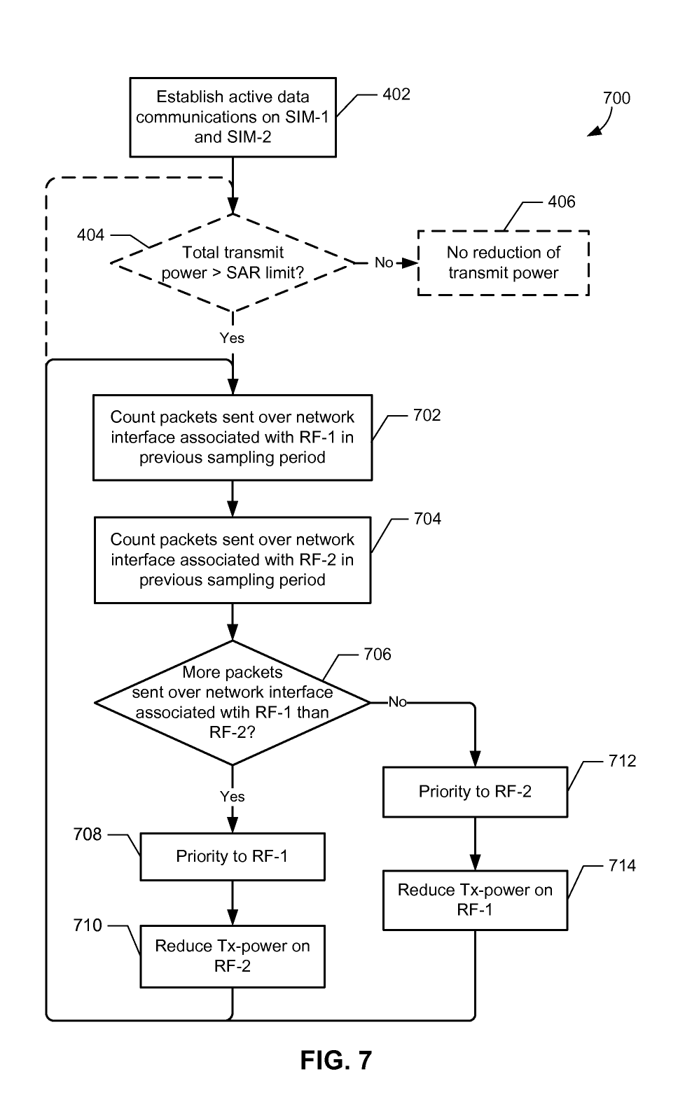

FIG. 7 illustrates an embodiment method for reducing total transmit power on a multi-SIM device based data that was previously sent. Method 700 may begin with the operations in blocks 402-406 described above with reference to FIG. 4. In block 702, the wireless device processor may determine the number of packets that were transmitted on a network interface associated with RF-1 during a previous sampling period (e.g., previous 1 ms), and in block 704, the wireless device processor may determine the number of packets that were transmitted on a network interface associated with RF-2 during the same sampling period. For example, the wireless device may use information provided in the /proc file system to determine these numbers in blocks 702 and 704. In determination block 706, the wireless device processor may determine whether, during the sampling period, more data packets were sent over the network interface associated with RF-1 than the network interface associated with RF-2 (or vice versa). If more data packets were sent over the network interface associated with RF-1 (i.e., determination block 706=“Yes”), the wireless device processor may give higher relative priority to RF-1 in block 708, and the transmit power on RF-2 (i.e., lower relative priority) may be reduced in block 710. If more data packets were not sent over the network interface associated with RF-1 (i.e., determination block 706=“No”), the wireless device processor may give higher relative priority to RF-2 in block 712, and the transmit power on RF-1 (i.e., lower relative priority) may be reduced in block 714. The operations in blocks 702-714 may be repeated periodically to dynamically account for changes in the relative amounts of data being transmitted by each RF resource. In this manner, the wireless device may update the determination of priority in response to changes in transmissions rates between the two communication links.

Optionally, the processor may also periodically determine whether the total transmit power would exceed the SAR limit without a power reduction in optional determination block 404. In this manner, the processor may stop reducing the power level of one of the RF resources when such mitigation actions are not required, thereby enabling both communication links to operate at power levels set by their respective networks.

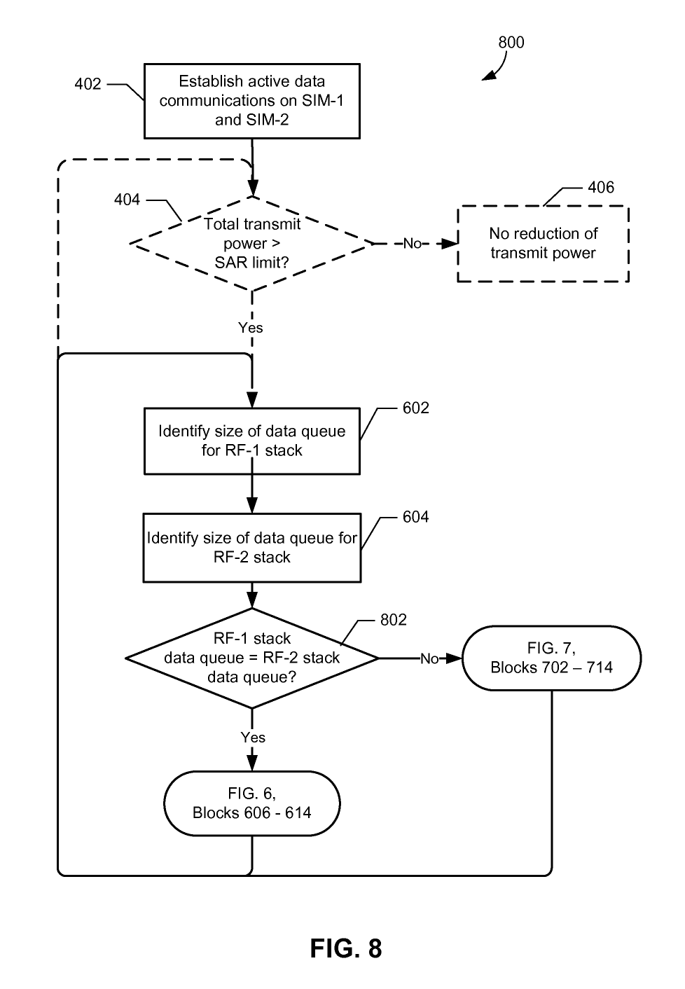

In alternative embodiments, the wireless device processor may implement one or both of the transmission priority methods 600 and 700 described above with reference to FIGS. 6 and 7. An example of this combination is embodiment method 800 illustrated in FIG. 8. In method 800 the processor may initially attempt to determine priority by comparing watermarks in a protocol layer of each RF resource, but may rely on the amounts of data transmitted over a preceding sampling interval if the watermarks (and thus the data pending transmission) are too similar.

Method 800 may begin with the operations in blocks 402-406 described above with reference to FIG. 4. Method 800 may proceed with the operations in blocks 602 and 604 described above with reference to FIG. 6. In determination block 802, the wireless device processor may determine whether the data queue associated with RF-1 is approximately the same size as (i.e., within a threshold difference of) the data queue associated with RF-2. If the data queues associated with RF-1 and RF-2 are not approximately the same size (i.e., determination block 802=“No”), the wireless device processor may perform the operations in blocks 606-614 described above with reference to FIG. 6. If the data queues associated with RF-1 and RF-2 are approximately the same size (i.e., determination block 802=“Yes”), the wireless device processor may perform the operations in blocks 702-714 described above with reference to FIG. 7.

Again, the processor may optionally periodically determine whether the total transmit power would exceed the SAR limit without a power reduction in optional determination block 404. In this manner, the processor may stop reducing the power level of one of the RF resources when such mitigation actions are not required, thereby enabling both communication links to operate at power levels set by their respective networks.

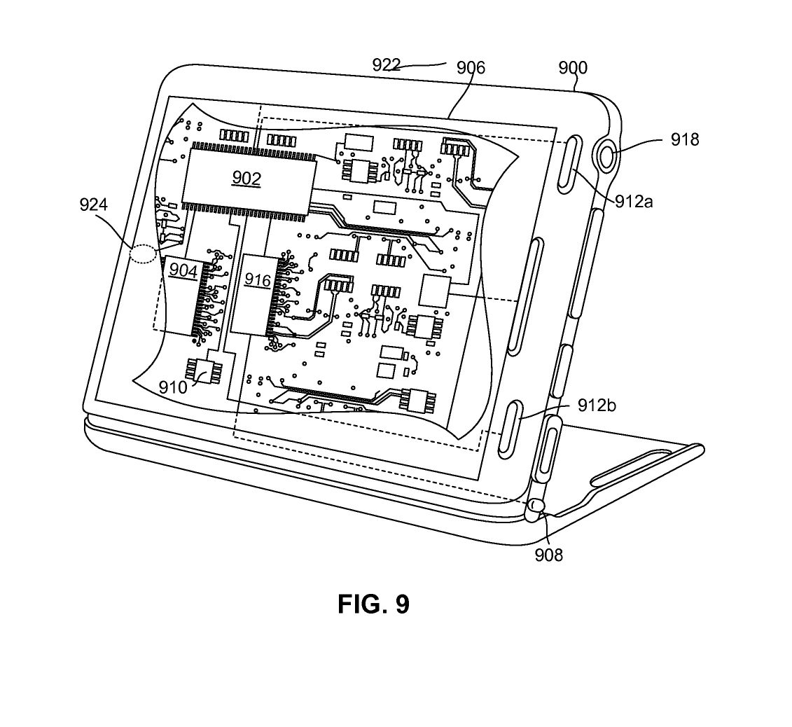

The various embodiments may be implemented in any of a variety of mobile devices, an example of which is illustrated in FIG. 9. For example, the mobile device 900 may include a processor 902 coupled to internal memories 904 and 910. Internal memories 904 and 910 may be volatile or non-volatile memories, and may also be secure and/or encrypted memories, or unsecure and/or unencrypted memories, or any combination thereof. The processor 902 may also be coupled to a touch screen display 906, such as a resistive-sensing touch screen, capacitive-sensing touch screen infrared sensing touch screen, or the like. Additionally, the display of the mobile device 900 need not have touch screen capability. Additionally, the mobile device 900 may have one or more antenna 908 for sending and receiving electromagnetic radiation that may be connected to a wireless data link and/or cellular telephone transceiver 916 coupled to the processor 902. The mobile device 900 may also include physical buttons 912a and 912b for receiving user inputs. The mobile device 900 may also include a power button 918 for turning the mobile device 900 on and off.

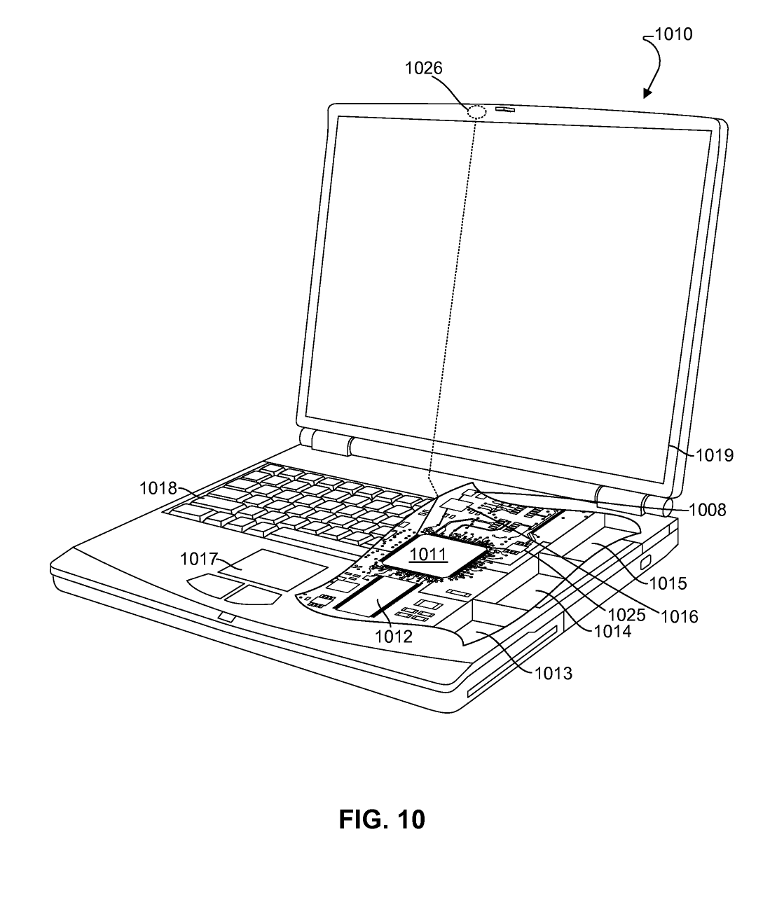

The various embodiments described above may also be implemented within a variety of personal computing devices, such as a laptop computer 1010 as illustrated in FIG. 10. Many laptop computers include a touch pad touch surface 1017 that serves as the computer's pointing device, and thus may receive drag, scroll, and flick gestures similar to those implemented on mobile computing devices equipped with a touch screen display and described above. A laptop computer 1010 will typically include a processor 1011 coupled to volatile memory 1012 and a large capacity nonvolatile memory, such as a disk drive 1013 of Flash memory. The computer 1010 may also include a floppy disc drive 1014 and a compact disc (CD) drive 1015 coupled to the processor 1011. The computer device 910 may also include a number of connector ports coupled to the processor 1011 for establishing data connections or receiving external memory devices, such as a USB or FireWire® connector sockets, or other network connection circuits for coupling the processor 1011 to a network. In a notebook configuration, the computer housing includes the touchpad 1017, the keyboard 1018, and the display 1019 all coupled to the processor 1011. Other configurations of the computing device may include a computer mouse or trackball coupled to the processor (e.g., via a USB input) as are well known, which may also be use in conjunction with the various embodiments.

The processors 902 and 1011 may be any programmable microprocessor, microcomputer or multiple processor chip or chips that can be configured by software instructions (applications) to perform a variety of functions, including the functions of the various embodiments described above. In some devices, multiple processors may be provided, such as one processor dedicated to wireless communication functions and one processor dedicated to running other applications. Typically, software applications may be stored in the internal memory 904, 910, 1012 and 1013 before they are accessed and loaded into the processors 902 and 1011. The processors 902 and 101 may include internal memory sufficient to store the application software instructions. In many devices the internal memory may be a volatile or nonvolatile memory, such as flash memory, or a mixture of both. For the purposes of this description, a general reference to memory refers to memory accessible by the processors 902, 1011 and 2902 including internal memory or removable memory plugged into the device and memory within the processor 902 and 1011, themselves.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

While the terms “first” and “second” are used herein to describe data transmission associated with a SIM and data receiving associated with a different SIM, such identifiers are merely for convenience and are not meant to limit the various embodiments to a particular order, sequence, type of network or carrier.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable medium or non-transitory processor-readable medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method of limiting total power transmissions of a multi-SIM wireless device participating in two or more active data communications supported by two or more radio frequency (RF) resources, comprising:
determining a priority of the two or more active data communications based upon a measured condition of the wireless device and attributes of the active data communications; and
reducing transmit power on at least one of the two or more RF resources supporting at least one of the two or more active data communications with lower priority.

2. The method of claim 1, further comprising:
measuring transmit power on each of the two or more RF resources; and
calculating a sum of transmit powers on all of the two or more RF resources.

3. The method of claim 2, wherein reducing transmit power on the at least one of the two or more RF resources is performed such that the sum of transmit powers on all of the two or more RF resources in the wireless device is below a predetermined level.

4. The method of claim 1, wherein reducing transmit power on at least one of the two or more RF resources comprises reducing transmit power by a predetermined amount.

5. The method of claim 1, wherein reducing transmit power on at least one of the two or more RF resources comprises:
temporarily shutting off the at least one of the two or more RF resources for a predetermined period of time; and
powering on the at least one of the two or more RF resources once the predetermined period of time has ended.

6. The method of claim 1, further comprising repeating operations of determining a priority of the two or more active data communications based upon a measured condition of the wireless device and attributes of the active data communications after a predetermined time interval.

7. The method of claim 1, wherein determining a priority of the two or more active data communications based upon a measured condition of the wireless device and attributes of the active data communications comprises:
identifying applications running on the wireless device;
identifying a foreground application among the identified running applications;
identifying at least one of the two or more active data communications as being associated with the foreground application; and
assigning higher priority to the active data communications associated with the foreground application.

8. The method of claim 1, wherein determining a priority of the two or more active data communications based upon a measured condition of the wireless device and attributes of the active data communications comprises:
determining a data transmission requirement on each of the two or more RF resources; and
assigning higher priority to one of the two or more RF resources associated with a greatest data transmission requirement.

9. The method of claim 8, wherein:
each of the two or more RF resources is associated with a network interface;
determining a data transmission requirement on each of the two or more RF resources comprises determining a number of pending data packets in a data queue associated with a protocol layer of each RF resource; and
the associated network interface is supporting at least one of the two or more active data communications.

10. The method of claim 8, wherein determining a data transmission requirement for each of the two or more RF resources comprises:
calculating an amount of data sent over each network interface supporting at least one of the two or more active data communications during a sampling period,
wherein each network interface is associated with at least one of the two or more RF resources.

11. The method of claim 10, wherein calculating an amount of data sent over each network interface supporting at least one of the two or more active data communications during a sampling period comprises counting a number of data packets that were sent by each network interface during the sampling period.

12. The method of claim 8, wherein each of the two or more RF resources is associated with a network interface, and wherein determining a data transmission requirement for each of the two or more RF resources comprises:
determining a number of pending data packets in a data queue associated with each network interface supporting at least one of the two or more active data communications;
determining whether a difference in the number of pending data packets between the data queues associated with the network interfaces is lower than a threshold difference; and
calculating an amount of data sent over each network interface supporting at least one of the two or more active data communications during a sampling period in response to determining that the difference in the number of pending data packets between the data queues associated with the network interfaces is lower than the threshold difference.

13. A wireless device, comprising:
a memory;
a first SIM associated with a first radio frequency (RF) resource;
a second SIM associated with a second RF resource; and
a processor coupled to the memory, the first RF resource, and the second RF resource, wherein the processor is configured with processor-executable instructions to perform operations comprising:
determining a priority of two or more active data communications supported by the two or more RF resources, wherein determining the priority is based upon a measured condition of the wireless device and attributes of the active data communications; and
reducing transmit power on at least one of the two or more RF resources supporting at least one of the two or more active data communications with lower priority.

14. The wireless device of claim 13, wherein the processor is configured with processor-executable instructions to perform operations further comprising:
measuring transmit power on each of the two or more RF resources; and
calculating a sum of the transmit powers on all of the two or more RF resources.

15. The wireless device of claim 14, wherein the processor is configured with processor-executable instructions to perform operations such that reducing transmit power on the at least one of the two or more RF resources comprises reducing transmit power so that the sum of transmit powers on all of the two or more RF resources in the wireless device is below a predetermined level.

16. The wireless device of claim 13, wherein the processor is configured with processor-executable instructions to perform operations such that reducing transmit power on at least one of the two or more RF resources comprises reducing transmit power by a predetermined amount.

17. The wireless device of claim 13, wherein the processor is configured with processor-executable instructions to perform operations such that reducing transmit power on at least one of the two or more RF resources comprises:
temporarily shutting off the at least one of the two or more RF resources for a predetermined period of time; and
powering on the at least one of the two or more RF resources once the predetermined period of time has ended.

18. The wireless device of claim 13, wherein the processor is configured with processor-executable instructions to perform operations further comprising:
repeating operations of determining a priority of the two or more active data communications based upon a measured condition of the wireless device and attributes of the active data communications after a predetermined time interval.

19. The wireless device of claim 13, wherein the processor is configured with processor-executable instructions to perform operations such that determining a priority of the two or more active data communications based upon a measured condition of the wireless device and attributes of the active data communications comprises:
identifying applications running on the wireless device;
identifying a foreground application among the identified running applications;
identifying at least one of the two or more active data communications as being associated with the foreground application; and
assigning higher priority to the at least one of the two or more active data communications associated with the foreground application.

20. The wireless device of claim 13, wherein the processor is configured with processor-executable instructions to perform operations such that determining a priority of the two or more active data communications based upon a measured condition of the wireless device and attributes of the active data communications comprises:
determining a data transmission requirement on each of the two or more RF resources; and
assigning higher priority to one of the two or more RF resources associated with a greatest data transmission requirement.

21. The wireless device of claim 20, wherein the processor is configured with processor-executable instructions to perform operations such that:
each of the two or more RF resources are associated with a network interface;
determining a data transmission requirement on each of the two or more RF resources comprises determining a number of pending data packets in a data queue associated with a protocol layer of each RF resource; and
the associated network interface is supporting at least one of the two or more active data communications.

22. The wireless device of claim 20, wherein the processor is configured with processor-executable instructions to perform operations such that determining a data transmission requirement for each of the two or more RF resources comprises:
calculating an amount of data sent over each network interface supporting at least one of the two or more active data communications during a sampling period,
wherein each network interface is associated with at least one of the two or more RF resources.

23. The wireless device of claim 22, wherein the processor is configured with processor-executable instructions to perform operations such that calculating an amount of data sent over each network interface supporting at least one of the two or more active data communications during a sampling period comprises counting a number of data packets that were sent by each network interface during the sampling period.

24. The wireless device of claim 20, wherein:
each of the two or more RF resources is associated with a network interface; and
the processor is configured with processor-executable instructions to perform operations such that determining a data transmission requirement for each of the two or more RF resources comprises:
determining a number of pending data packets in a data queue associated with each network interface supporting at least one of the two or more active data communications;
determining whether a difference in the number of pending data packets between the data queues associated with the network interfaces is lower than a threshold difference; and
calculating an amount of data sent over each network interface supporting at least one of the two or more active data communications during a sampling period in response to determining that the difference in the number of pending data packets between the data queues associated with each network interface is lower than the threshold difference.

25. A multi-SIM wireless device, comprising:
two or more radio frequency (RF) resources configured to support two or more active data communications;
means for determining a priority of the two or more active data communications based upon a measured condition of the wireless device and attributes of the active data communications; and
means for reducing transmit power on at least one of the two or more RF resources supporting at least one of the two or more active data communications with lower priority.

26. The multi-SIM wireless device of claim 25, further comprising:
means for measuring transmit power on each of the two or more RF resources; and
means for calculating a sum of transmit powers on all of the two or more RF resources.

27. The multi-SIM wireless device of claim 26, wherein means for reducing transmit power on the at least one of the two or more RF resources comprises means for reducing transmit power on the at least one of the two or more RF resources such that the sum of transmit powers on all of the two or more RF resources in the wireless device is below a predetermined level.

28. The multi-SIM wireless device of claim 25, wherein means for reducing transmit power on at least one of the two or more RF resources comprises means for reducing transmit power by a predetermined amount.

29. The multi-SIM wireless device of claim 25, wherein means for reducing transmit power on at least one of the two or more RF resources comprises:
means for temporarily shutting off the at least one of the two or more RF resources for a predetermined period of time; and
means for powering on the at least one of the two or more RF resources once the predetermined period of time has ended.

30. The multi-SIM wireless device of claim 25, further comprising means for repeating operations of determining a priority of the two or more active data communications based upon a measured condition of the wireless device and attributes of the active data communications after a predetermined time interval.

31. The multi-SIM wireless device of claim 25, wherein means for determining a priority of the two or more active data communications based upon a measured condition of the wireless device and attributes of the active data communications comprises:
means for identifying applications running on the wireless device;
means for identifying a foreground application among the identified applications running on the wireless device;
means for identifying at least one of the two or more active data communications as being associated with the foreground application; and
means for assigning higher priority to the at least one of the two or more active data communications associated with the foreground application.

32. The multi-SIM wireless device of claim 25, wherein means for determining a priority of the two or more active data communications based upon a measured condition of the wireless device and attributes of the active data communications comprises:
means for determining a data transmission requirement on each of the two or more RF resources; and
means for assigning higher priority to one of the two or more RF resources associated with a greatest data transmission requirement.

33. The multi-SIM wireless device of claim 32, wherein:
each of the two or more RF resources are associated with a network interface; and
means for determining a data transmission requirement on each of the two or more RF resources comprises means for determining a number of pending data packets in a data queue associated with a protocol layer of each RF resource; and
the associated network interface is supporting at least one of the two or more active data communications.

34. The multi-SIM wireless device of claim 32, wherein means for determining a data transmission requirement for each of the two or more RF resources comprises:
means for calculating an amount of data sent over each network interface supporting at least one of the two or more active data communications during a sampling period,
wherein each network interface is associated with at least one of the two or more RF resources.

35. The multi-SIM wireless device of claim 34, wherein means for calculating an amount of data sent over each network interface supporting at least one of the two or more active data communications during a sampling period comprises means for counting a number of data packets that were sent by each network interface during the sampling period.

36. The multi-SIM wireless device of claim 32, wherein:
each of the two or more RF resources is associated with a network interface; and
means for determining a data transmission requirement for each of the two or more RF resources comprises:
means for determining a number of pending data packets in a data queue associated with each network interface supporting at least one of the two or more active data communications;
means for determining whether a difference in the number of pending data packets between the data queues associated with the network interfaces is lower than a threshold difference; and
means for calculating an amount of data sent over each network interface supporting at least one of the two or more active data communications during a sampling period in response to determining that the difference in the number of pending data packets between the data queues associated with the network interfaces is lower than the threshold difference.

37. A non-transitory processor-readable storage medium having stored thereon processor-executable instructions configured to cause a processor of a multi-SIM wireless device to perform operations comprising:
determining a priority of two or more active data communications supported by two or more radio frequency (RF) resources, wherein the priority is determined based upon a measured condition of the wireless device and attributes of the active data communications; and
reducing transmit power on at least one of the two or more RF resources supporting at least one of the two or more active data communications with lower priority.

38. The non-transitory processor-readable storage medium of claim 37, wherein the stored processor-executable instructions are configured to cause a processor of a multi-SIM wireless device to perform operations further comprising:
measuring transmit power on each of the two or more RF resources; and
calculating a sum of transmit powers on all of the two or more RF resources.

39. The non-transitory processor-readable storage medium of claim 38, wherein the stored processor-executable instructions are configured to cause a processor of a multi-SIM wireless device to perform operations such that reducing transmit power on the at least one of the two or more RF resources is performed such that the sum of transmit powers on all of the two or more RF resources in the wireless device is below a predetermined level.

40. The non-transitory processor-readable storage medium of claim 37, wherein the stored processor-executable instructions are configured to cause a processor of a multi-SIM wireless device to perform operations such that reducing transmit power on at least one of the two or more RF resources comprises reducing transmit power by a predetermined amount.

41. The non-transitory processor-readable storage medium of claim 37, wherein the stored processor-executable instructions are configured to cause a processor of a multi-SIM wireless device to perform operations such that reducing transmit power on at least one of the two or more RF resources comprises:
temporarily shutting off the at least one of the two or more RF resources for a predetermined period of time; and
powering on the at least one of the two or more RF resources once the predetermined period of time has ended.

42. The non-transitory processor-readable storage medium of claim 37, wherein the stored processor-executable instructions are configured to cause a processor of a multi-SIM wireless device to perform operations further comprising repeating operations of determining a priority of the two or more active data communications based upon a measured condition of the wireless device and attributes of the active data communications after a predetermined time interval.

43. The non-transitory processor-readable storage medium of claim 37, wherein the stored processor-executable instructions are configured to cause a processor of a multi-SIM wireless device to perform operations such that determining a priority of the two or more active data communications based upon a measured condition of the wireless device and attributes of the active data communications comprises:
identifying applications running on the wireless device;
identifying a foreground application among the identified running applications;
identifying at least one of the two or more active data communications as being associated with the foreground application; and
assigning higher priority to the at least one of the two or more active data communications associated with the foreground application.

44. The non-transitory processor-readable storage medium of claim 37, wherein the stored processor-executable instructions are configured to cause a processor of a multi-SIM wireless device to perform operations such that determining a priority of the two or more active data communications based upon a measured condition of the wireless device and attributes of the active data communications comprises:
determining a data transmission requirement on each of the two or more RF resources; and
assigning higher priority to one of the two or more RF resources associated with a greatest data transmission requirement.

45. The non-transitory processor-readable storage medium of claim 44, wherein the stored processor-executable instructions are configured to cause a processor of a multi-SIM wireless device to perform operations such that:
each of the two or more RF resources are associated with a network interface;
determining a data transmission requirement on each of the two or more RF resources comprises determining a number of pending data packets in a data queue associated with a protocol layer of each RF resource; and
the associated network interface is supporting at least one of the two or more active data communications.

46. The non-transitory processor-readable storage medium of claim 44, wherein the stored processor-executable instructions are configured to cause a processor of a multi-SIM wireless device to perform operations such that determining a data transmission requirement for each of the two or more RF resources comprises:
calculating an amount of data sent over each network interface supporting at least one of the two or more active data communications during a sampling period,
wherein each network interface is associated with at least one of the two or more RF resources.

47. The non-transitory processor-readable storage medium of claim 46, wherein the stored processor-executable instructions are configured to cause a processor of a multi-SIM wireless device to perform operations such that calculating an amount of data sent over each network interface supporting at least one of the two or more active data communications during a sampling period comprises counting a number of data packets that were sent by each network interface during the sampling period.

48. The non-transitory processor-readable storage medium of claim 44, wherein the stored processor-executable instructions are configured to cause a processor of a multi-SIM wireless device to perform operations such that:
each of the two or more RF resources is associated with a network interface; and
determining a data transmission requirement for each of the two or more RF resources comprises:
determining a number of pending data packets in a data queue associated with each network interface supporting at least one of the two or more active data communications;
determining whether a difference in the number of pending data packets between the data queues associated with the network interfaces is lower than a threshold difference; and
calculating an amount of data sent over each network interface supporting at least one of the two or more active data communications during a sampling period in response to determining that the difference in the number of pending data packets between the data queues associated with the network interfaces is lower than the threshold difference.
